(19) United States
(12) Patent Application Publication
(10) Pub. No.: US 2008/0290077 A1
(43) Pub. Date: Nov. 27, 2008

(54) Separation of transparent glasses and systems and methods therefor

(76) Inventors: Jeffery Alan DeMeritt, Painted Post, NY (US); Stuart Gray, Corning, NY (US); Alexander Streltsov, Corming, NY (US); Luis Alberto Zenteno, Painted Post, NY (US)

Correspondence Address: CORNING INCORPORATED, SP-TI-3-1, CORNING, NY, 14831, US

(21) Appl. No.: 11/805,234

(22) Filed: May 22, 2007

(51) Int. Cl. B23K 26/08

(52) U.S. Cl. 219/121.67; 219/121.72

(57) ABSTRACT

Disclosed are systems and methods for cutting one or more glass sheets. A system is provided comprising a first mirror having a first reflective surface and a second reflective surface that is spaced from and opposes the first reflective surface to define a cavity between the mirrors. An aperture can be defined in the first mirror. Furthermore, a laser beam can be provided that is configured to emit a beam through the aperture into the cavity. Beams reflected in the cavity, in one aspect, define a common focus point through which the glass sheet can be translated to cause the cutting of the glass sheets. A means for translating the glass sheet through the cavity is provided, in one aspect.

### FIELD OF THE INVENTION

The present invention relates to systems and methods for cutting one or more glass sheets. More particularly, the present invention relates to the use of a plurality of reflected laser beams to cut one or more glass sheets.

### TECHNICAL FIELD

In the past, several different methods and techniques have been used to cut glass sheets. Generally, the requirements of an ideal process for cutting glass sheets include a high run rate, low cost, high edge strength, and minimum post-processing. To increase production, it is often desired to cut a stack of glass sheets at one time.

The most widely used method is mechanical scoring using a wheel made of a hard material and breaking the glass along the score line. Mechanical scoring generally meets the first three requirements; however, the debris generated during scoring and breaking collects on the glass surface and requires thorough cleaning. The need for thorough cleaning increases the total cost of this process. As may be appreciated, mechanical scoring cannot be used to cut through a stack of glass sheets at the same time, thus increasing the time needed to cut through more than one glass sheet.

To address the problem of debris collection along the glass sheet, a CO₂-based laser approach has been developed. The moving laser beam creates a temperature gradient on the surface of the glass sheet, which is enhanced by a coolant (such as a gas or liquid) that follows the laser beam at some distance. While the CO₂-based laser approach provides generally acceptable edge quality, the nature of the surface heating by the CO₂ laser does not allow for cutting stacks of glass sheets. Additionally, the maintenance cost and/or cost of ownership of the CO₂ laser is significantly higher than a mechanical scoring system as described above.

Another solution has been proposed and involves the use of solid-state lasers, such as YAG lasers. The emission wavelength of these lasers is generally in the near-infrared (NIR) range, where glasses tend to have moderate to low absorption. These methods rely on temperature gradients to cause stresses and cracks in the glass sheets. To achieve the required temperatures, multi-pass beam schemes have been implemented. Typically, these multi-pass schemes require an unfocused beam to be passed through the same spot in the glass for a limited number of passes. This type of scheme has been insufficient for highly-transmissive glasses (i.e., those having low absorption) or for glass with low coefficient of thermal expansion (CTE) that requires high heating temperatures to be cut. Unlike the CO₂-based laser approach, the solid-state laser approach heats the glass through its entire thickness and thus allows for cutting stacks of multiple glass sheets. However, the limited number of passes results in considerable difficulties in cutting glass with low absorption.

Thus, there is a need in the art for methods and systems for cutting sheets of glass at a high run rate and low cost that produce high edge strength of the glass sheets while minimizing post-processing and that can be used to cut glass sheets having any absorption rate.

### SUMMARY OF THE INVENTION

The present invention provides systems and methods for cutting at least one glass sheet. In one aspect, a system is provided that comprises a first mirror comprising a first reflective surface and a second mirror comprising a second reflective surface that is spaced from and opposes the first reflective surface and defines a cavity between the first and second mirrors. In a further aspect, the first mirror defines an aperture through the first reflective surface. The system, in one aspect, further comprises a laser configured to emit a beam through the aperture into the cavity. In yet a further aspect, the system comprises means for translating the at least one glass sheet through the cavity, such as in a machine direction.

A method for cutting at least one glass sheet is provided that comprises providing a first mirror comprising a first reflective surface and a second mirror comprising a second reflective surface that is spaced from and opposes the first reflective surface to define a cavity between the first and second mirrors. The first mirror, in one aspect, defines an aperture through the first reflective surface. The method, in a further aspect, comprises providing a laser that is configured to emit a beam and projecting the beam through the aperture into the cavity. In yet a further aspect, the method comprises translating the at least one glass sheet through the cavity such as in a machine direction.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

FIG. 1 is a schematic diagram of a system for laser separation of glass, according to one aspect of the present invention.

FIG. 2 is a schematic diagram of a system for laser separation of glass, according to another aspect of the present invention.

FIG. 3 is a schematic diagram showing a plan view of a system for laser separation of glass, such as shown in FIG. 2, according to one aspect of the present invention.

FIG. 4 is a schematic diagram of a system for laser separation of glass, according to yet another aspect of the present invention.

FIG. 5A is a graph illustrating the results of stress measurements taken approximately in the center of the line of separation of a glass sheet.

FIG. 5B is a graph illustrating the results of stress measurements taken approximately at the end of the line of separation along an edge of a glass sheet.

FIG. 6 illustrates an exemplary profile of a common focus point that results from the use of a split laser beam having orthogonal polarizations.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a “beam” includes embodiments having two or more such beams unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

As used herein, the terms “cut” and “separate”, and derivatives thereof, are intended to have synonymous meanings that describe, but are not limited to, the act or process of dividing a sheet of glass or other material into one or more separate pieces.

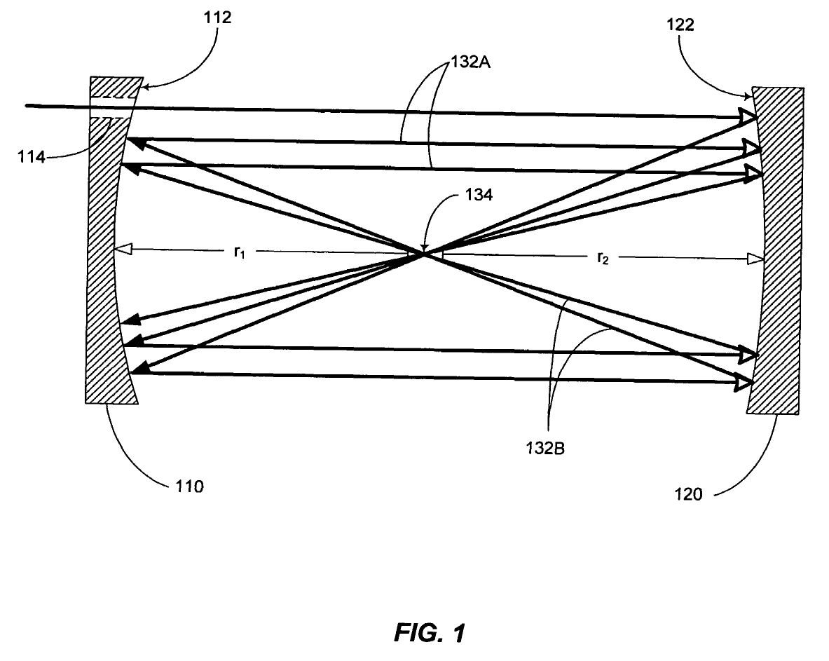

As briefly summarized above, in one aspect of the present invention, a system is provided for cutting at least one glass sheet. With reference to FIG. 1, an exemplary system can comprise a first mirror 110 and a second mirror 120. In one aspect, the first mirror comprises a first reflective surface 112. The first mirror, in a particular aspect, can define an aperture 114 extending through the mirror and through the first reflective surface. Likewise, the second mirror can comprise a second reflective surface 122. In a further aspect, the mirrors can be positioned such that the respective reflective surfaces face each other and such that a cavity is defined between the mirrors.

According to a further aspect of the present invention, the system can comprise a laser configured to emit a beam through the aperture 114 in the first mirror into the cavity. The beam can be reflected off of at least the second reflective surface 122 a plurality of times to form a plurality of reflected beams 132B. Similarly, the beam can be reflected off of the first reflective surface 112 to form additional reflected beams 132A. In one aspect, the plurality of reflected beams defines a beam path plane. Optionally, in one aspect, the plurality of reflected beams may not define a single beam path plane.

In another aspect, the first mirror can be shaped and configured to allow the beam to be emitted into the cavity other than through an aperture. For example, a portion of an edge of the first mirror can be removed and the beam can be projected approximately at the position where the mirror portion was removed. If the first mirror is substantially circular, for instance, a portion of the first mirror can be removed along a chord of the circle to form a mirror that is roughly “D” shaped. The laser can be positioned at the flat edge of the mirror (at the chord) and the beam can be emitted into the cavity to reflect off of the second reflective surface. Alternatively, the first mirror can be provided with a shape that allows for the beam to be emitted into the cavity proximate an edge of the first mirror to reflect off of the second reflective surface.

In one aspect, the first and second mirrors can be concave relative to the cavity and each can have a respective first and second radius of curvature. In one aspect, the radii of curvature of each of the first and second mirrors can be substantially the same. Optionally, the first radius of curvature and the second radius of curvature can differ. In a particular aspect, the first radius of curvature is less than the second radius of curvature. By selecting different radii of curvature, the passage of the reflected beams through the aperture and out of the cavity can be substantially avoided.

According to various aspects, the mirrors can be positioned such that the reflective surfaces are spaced apart at a predetermined distance. In a particular aspect, the predetermined distance is substantially equal to or less than the sum of the first radius of curvature r, and the second radius of curvature r₂. For example, as shown in FIG. 1, each reflective surface can define opposing midpoints at which the distance between the reflective surfaces is at a maximum. In this aspect, the distance can be substantially equal to the sum of the respective radii of curvature. In a particular aspect, the first radius of curvature, second radius of curvature, or both can be selected such that the beams reflected off of the second reflective surface define a common focus point 134. The distance at which the reflective surfaces are spaced can also be selected in combination with the first radius of curvature, second radius of curvature, or both, such that the beams reflected off the of the second reflective surface define a common focus point. For example, in a particular aspect, the first radius of curvature can be selected to be less than the second radius of curvature, and the reflective surfaces can be spaced apart (defined at the opposing midpoints) at a distance substantially equal to the sum of the first and second radii of curvature.

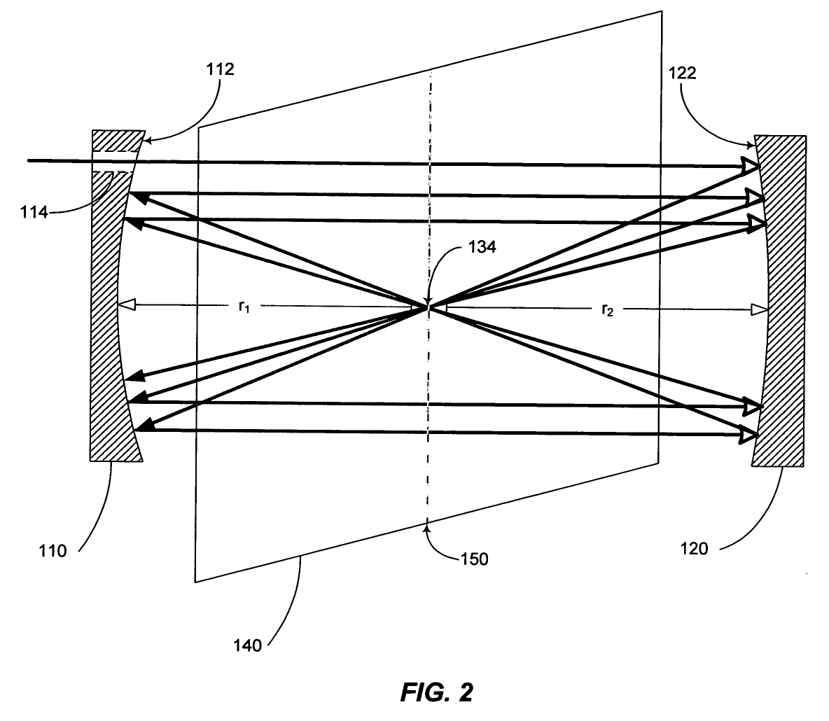

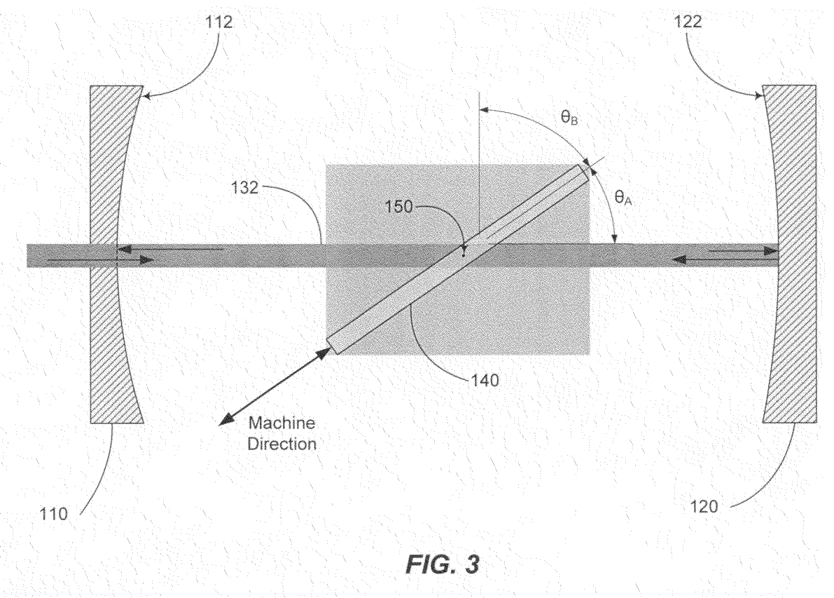

The system of the present invention, according to a further aspect, can comprise means for translating the at least one glass sheet through the cavity in a machine direction. In one aspect, the machine direction can be substantially linear. Optionally, the machine direction can be substantially non-linear, such as arcuate or a pattern of several connected linear, but non-parallel, directions. With reference to FIGS. 2 and 3, the means for translating, in one aspect, is configured to translate the at least one glass sheet through the cavity to and through a first position in which the plane of the glass sheet and the beam path plane define a common axis 150. In the first position, the glass sheet plane can define a predetermined angle with respect to the beam path plane θ_{A} and a predetermined complementary angle θ_{B} with respect to a third plane that comprises the common axis and is transverse to the beam path plane.

The means for translating can be configured to translate the glass sheet 140 in the machine direction through the cavity such that the predetermined angle is maintained while at least a portion of the glass sheet passes through the common focus point. In one aspect, the machine direction can be substantially linear along an axis that is perpendicular to the common axis and is at the predetermined angle in relation to the beam path plane, such as shown in FIG. 3. Optionally, the machine direction can be substantially linear in a direction parallel to the common axis. As may be appreciated, various machine directions are possible that are configured to pass at least a portion of the glass sheet through the common focus point while maintaining the predetermined angle and are not intended to be limited to those described above.

The means for translating can be configured to translate the glass sheet through the cavity at a predetermined speed. It is contemplated that the predetermined speed can be selected depending on the strength of the laser and the characteristics of the glass sheet (i.e., absorption, coefficient of thermal expansion, etc.). Therefore, in various aspects, it is contemplated that higher speeds of translation (and thus, faster cutting times) can be achieved using lasers of higher power. The present invention is not intended to be limited to a particular laser power or a particular predetermined speed. Thus, it is contemplated that the predetermined speed can be selected to have any value depending on the factors described above and is not intended to be limited to any exemplary values described herein.

In one aspect, the predetermined complementary angle θ_{B} is substantially Brewster's angle. Optionally, the predetermined complementary angle can be from about 54 to about 60 degrees, including 54, 55, 56, 57, 58, 59 and 60 degrees. In another aspect, the predetermined complementary angle can be from about 55 to about 57 degrees, including 55, 55.5, 56, 56.5 and 57 degrees. In a particular aspect, the predetermined complementary angle is approximately 56 degrees.

In one aspect, the laser can be configured to emit a beam that is polarized. In a further aspect, the laser beam can be polarized in a plane transverse to the common axis 150, such as being linearly p-polarized. In this aspect, losses on Fresnel reflection can be minimized, and thus the effective absorption by the glass sheet can be increased. Absorption by the glass sheet can also depend on the type of glass being used. For example, an exemplary glass sheet having an absorption of less than about 0.001/cm can be used. At this relatively low absorption, the need for a p-polarized laser beam can be more critical. An exemplary glass sheet comprising glass having an absorption of about 0.001/cm to about 0.01/cm can also be used. Alternatively, an exemplary glass sheet comprising glass having an absorption of about 0.01/cm to about 0.1/cm can be used. Optionally, an exemplary glass sheet comprising glass having an absorption of greater than about 0.1/cm, such as between about 0.1/cm and about 1.0/cm, can similarly be used.

Glass sheets having various coefficients of thermal expansion (CTE) can also be used. For example, a glass sheet comprising glass having a CTE of about 1×10⁻⁶/° C. to about 2×10⁻⁶/° C. can be used. Optionally, a glass sheet comprising glass having a CTE of about 2×10⁻⁶/° C. to about 4×10^{31 6}/° C. can be used. In yet another aspect, a glass sheet comprising glass having a CTE of about 4×10⁻⁶/° C. to about 1×10⁻⁵/° C. can be used. In a particular aspect, a glass sheet can comprise glass having a CTE of approximately 3.7×10⁻⁶/° C.

In various aspects, glass sheets having various combinations of absorption and CTE values, such as any of those described above, can be used. For example, a glass sheet can comprise glass having an absorption of about 0.01/cm to about 0.1/cm and a coefficient of thermal expansion of about 2×10⁻⁶/° C. to about 4×10⁻⁶/° C. In a particular aspect, a glass sheet can be used that has an absorption of about 0.09/cm to about 0.1/cm, and a CTE of approximately 3.7×10⁻⁶/° C. it is also contemplated that sheets that are cut by systems and according to methods described herein are not intended to be limited to glass, but can comprise materials having similar properties (such as, but not limited to, absorption and CTE) as glass, such as glass-ceramics, crystal and the like.

In one aspect, the means for translating can be configured to translate the glass sheet through the cavity more than once. In this aspect, it is contemplated that the absorption by the glass sheet is increased with each subsequent pass through the common focus point of the laser beam. It is also contemplated that glass sheets comprising glass of lower absorption may require more passes through the cavity to achieve separation as compared to glass sheets comprising glass of relatively higher absorption. As described above, in a particular aspect, the first radius of curvature r₁ can be less than the second radius of curvature r₂. If the difference in radii is relatively small, the reflected beams may be slower in converging to the common focus point.

In a particular aspect of the present invention, the at least one glass sheet comprises a plurality of glass sheets in a stacked arrangement. In this aspect, the means for translating can be configured to translate the stack of glass sheets through the cavity in a machine direction. The machine direction can vary, as described above. It is contemplated that, according to various aspects of the present invention as described herein, absorption of the laser beam occurs through the entire thickness of each glass sheet such that each of the stacked glass sheets can be separated substantially simultaneously. Glass sheets of varying sizes, including various length and height dimensions in the plane of the glass sheet as well as various thicknesses, can be used.

Various types of lasers can be used to achieve the result of separating a glass sheet, according to aspects of the present invention. For example, a continuous wave (“CW”) laser can be used, particularly one of high-power (such as, but not limited to, a laser having a power of 200 W or more). A fiber laser, such as but not limited to a Yb fiber laser, can also be used. A diode pigtailed laser can also be used. In one aspect, a laser operating in the near infrared wavelength band can be used. In other aspects, it is contemplated that the laser can operate in wavelength bands other than the near infrared wavelength band.

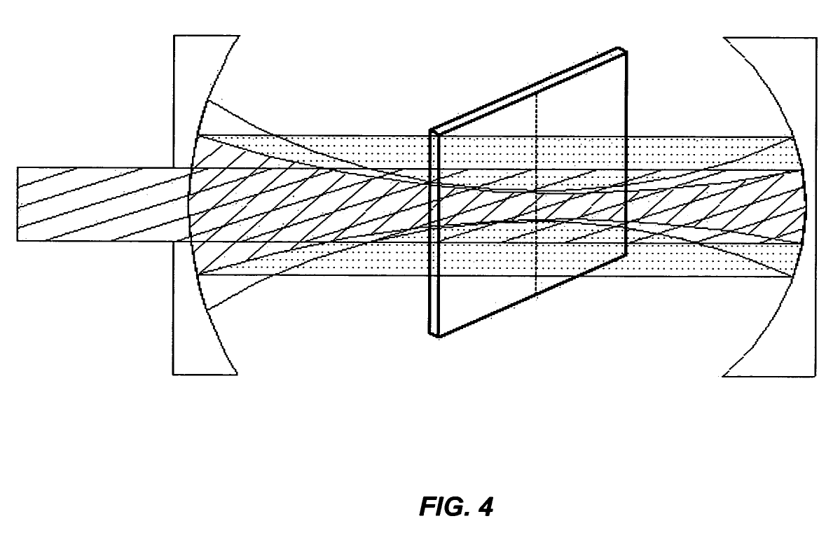

In an alternative aspect, such as illustrated in the exemplary system of FIG. 4, two mirrors can be provided, with a first mirror defining an aperture through approximately the midpoint of the mirror. The incident beam of the laser can be emitted into the cavity through the aperture. In this particular aspect, the beam expands in each subsequent pass or reflection. Due to the overlapping of the reflected beams 132A, 132B, it is contemplated that efficiency of heating, and consequently separating, the glass sheets is increased. However, additional losses of laser power may occur, such as the loss of portions of the beam through the aperture and out of the cavity, which can potentially be coupled back into the laser and affect the laser's stability.

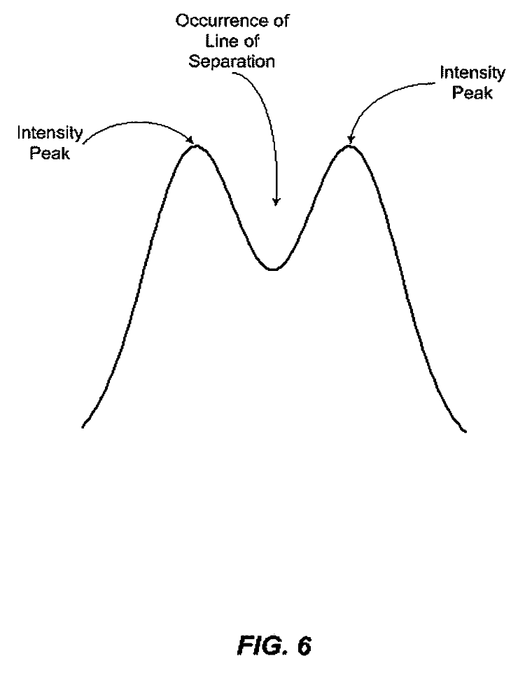

In a further alternative aspect, the laser beam emitted from the laser can be split with a polarizing beam splitter into two beams having orthogonal polarizations. Thus, one polarization can be turned by 90° with a λ/2 plate and the two collinearly polarized beams can be emitted at slightly different angles into the cavity. The resulting profile of the common focus point is illustrated in FIG. 6. It is contemplated that, in this aspect, the line of separation occurs between the two intensity peaks. In this aspect, precise crack propagation control can be achieved.

According to yet another aspect of the present invention, a method is provided for cutting at least one glass sheet. The method, in one aspect, comprises providing a first mirror having a first reflective surface and defining an aperture through the first reflective surface, and providing a second mirror comprising a second reflective surface. The second mirror can be positioned such that the second reflective surface is spaced from and opposes the first reflective surface, such that a cavity is defined between the first and second reflective surfaces.

In a further aspect, a laser is provided that is configured to emit a beam. The beam can be projected through the aperture into the cavity. In a particular aspect, the laser can be positioned such that the beam emitted from the laser is reflected off of at least the second reflective surface a plurality of times to form a plurality of reflected beams that define a beam path plane.

According to a particular aspect, the first reflective surface can be concave relative to the cavity and have a first radius of curvature; similarly, the second reflective surface can be concave relative to the cavity and have a second radius of curvature. In a further particular aspect, the second radius of curvature can be selected such that the plurality of reflected beams defines a common focus point, which lies in the beam path plane.

The method, according to one aspect, further comprises translating the at least one glass sheet through the cavity in a machine direction. In one aspect, this step comprises translating the at least one glass sheet to and through a first position in which the plane of the glass sheet and the beam path plane define a common axis comprising the common focus point. The first position can further define a predetermined angle with respect to the beam path plane and a predetermined complementary angle with respect to a third plane that comprises the common axis and is transverse to the beam path plane. In a further aspect, translating the glass sheet through the cavity comprises maintaining the predetermined angle. In this aspect, the glass sheet can be translated along a second axis that is perpendicular to the common axis and is at the predetermined angle in relation to the beam path plane. As described above, in one aspect, the predetermined complementary angle can be substantially Brewster's angle.

In one aspect, the glass sheet can be translated through the cavity at a predetermined speed. The predetermined speed can range from about 2 mm/sec to about 6 mm/sec. Optionally, the predetermined speed can be approximately 4 mm/sec. In one aspect, the predetermined speed can be any speed that results in a controlled propagation of the line of separation. For example, a selected speed that is too low can result in overheating of the glass sheet and a line of separation that propagates in an uncontrolled manner; conversely, a selected speed that is too high can be insufficient in inducing thermal stress and may be insufficient in initiating the line of separation. Thus, it is contemplated that any predetermined speed can be used, depending on the particular absorption of the glass, CTE of the glass, power of the laser, and other factors.

The method, according to a further aspect, comprises scribing a portion of an edge of the at least one glass sheet prior to translating the glass sheet through the cavity. In a particular aspect, it is contemplated that the edge is scribed at a point that is desired to be the starting point of the line of separation. As described above, in one aspect the plurality of glass sheets can comprise a plurality of glass sheets arranged in a stacked arrangement. In this aspect, each glass sheet can be scribed at substantially the same location along each respective glass sheet edge so that the lines of separation of each of the glass sheets are substantially parallel.

Lastly, it should be understood that while the present invention has been described in detail with respect to certain illustrative and specific embodiments thereof, it should not be considered limited to such, as numerous modifications are possible without departing from the broad spirit and scope of the present invention as defined in the appended claims.

### EXAMPLES

To further illustrate the principles of the present invention, the following examples are put forth so as to provide those of ordinary skill in the art with a complete disclosure and description of how the ceramic articles and methods claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is degrees C. or is at ambient temperature, and pressure is at or near atmospheric.

An experiment was conducted in which a first mirror having a radius of curvature of 10 cm and a second mirror having a radius of curvature of 12.5 cm were utilized. The mirrors were separated by 22.5 cm at the midpoints of their reflective surfaces. A 5 cm×5 cm Eagle²⁰⁰⁰® glass sheet sample was placed at an angle in which the predetermined complementary angle (i.e., θ_{B} in FIG. 3) was the Brewster angle. The glass sheet was mounted on a motorized translation mechanism. A Yb continuous-wave (“CW”), unpolarized, 1060-nm fiber oscillator laser, having an output power of 250 W, was used to emit a beam through an aperture in the first mirror into the cavity defined by the space between the two mirrors. The beam spot size (i.e., at the common focus point) on the glass sheet was estimated to be approximately 50 μm. Due to the use of an unpolarized laser, it was estimated that approximately half of the laser's output power was lost on reflection. It was estimated that, based on the alignment of the mirrors and the estimated losses due to reflection, approximately 10 to 12 passes would be needed to separate the glass sheet.

The glass sheet was translated through the common focus point in a linear machine direction along an axis perpendicular to the common axis and at the Brewster angle (described above). The glass sheet was translated at approximately 4 mm/sec. The glass sample was scribed along one edge within ±1 mm from the beam path. At this distance from the beam path, the line of separation of the glass sheet began to deviate slightly from the line at which the glass sheet was passed through the common focus point. However, the line of separation generally was guided by the laser beam and did not propagate freely by itself. Other glass sheet samples were tested and it was determined that at speeds lower than 4 mm/sec, for the particular type of glass used, the glass overheated and line of separation began to propagate freely and was more difficult to control.

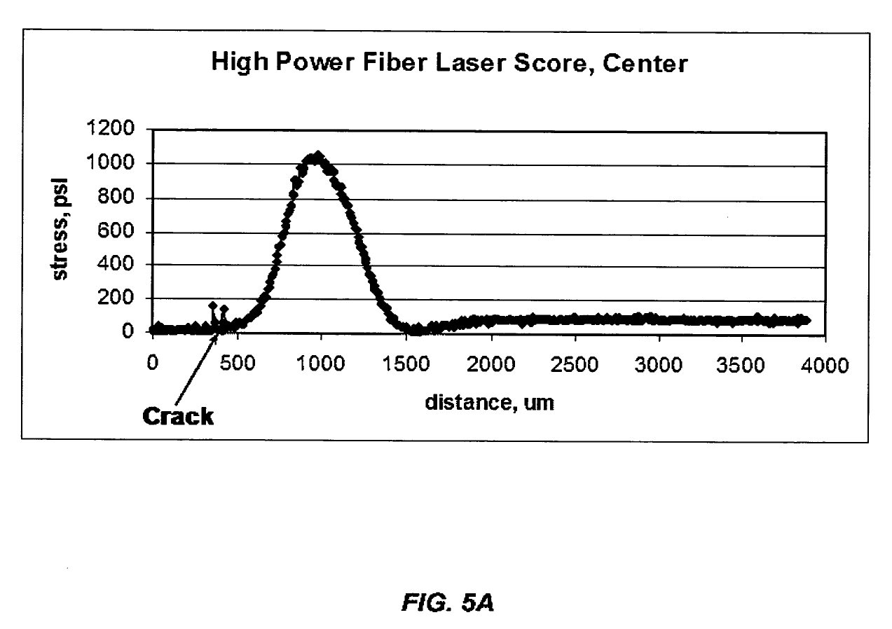

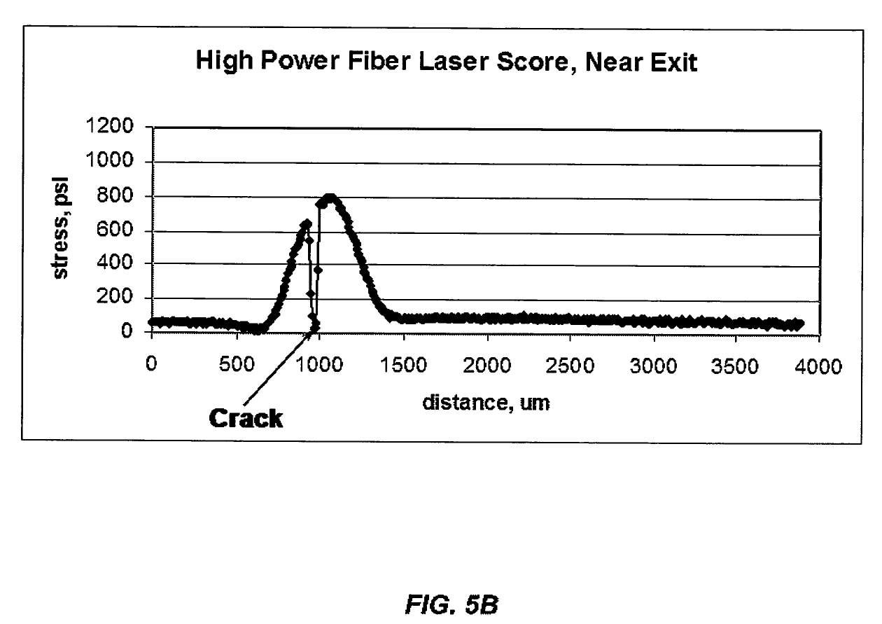

Stress measurements along and in the vicinity of the line of separation were calculated based on birefringence measurements. FIGS. 5A and 5B show the results of the tests. FIG. 5A shows the results taken approximately in the center of the glass sheet. As can be seen, in the middle of the line of separation, the separation occurred slightly away from the beam path. At the exit, as shown in FIG. 5B, the line of separation occurred almost at the stress maximum. In both locations, the stress magnitude was approximately 800 to 1000 psi. The results of this experiment demonstrate that using the above-described set up of mirrors, temperatures and stresses sufficient to separate a glass sheet can be achieved despite low absorption of the laser beam. Thus, it is expected that if a polarized laser (such as, but not limited to, a p-polarized laser) were used, improved results would be achieved.

1. A system for cutting at least one glass sheet comprising:
a first mirror comprising a first reflective surface;
a second mirror comprising a second reflective surface that is spaced from and opposes the first reflective surface, and wherein the first reflective surface and the second reflective surface define a cavity therebetween;
a laser configured to emit a beam into the cavity, wherein the beam is reflected off of at least the second reflective surface a plurality of times to form a plurality of reflected beams; and
means for translating the at least one glass sheet through the cavity in a machine direction.

2. The system of claim 1, wherein the first reflective surface is concave relative to the cavity and has a first radius of curvature, and wherein the second reflective surface is concave relative to the cavity and has a second radius of curvature.

3. The system of claim 2, wherein the second reflective surface is spaced from the first reflective surface at a predetermined distance that is substantially equal to or less than the sum of the first radius of curvature and the second radius of curvature.

4. The system of claim 2, wherein the first radius of curvature is less than the second radius of curvature.

5. The system of claim 2, wherein at least one of first radius and second radius of curvature is selected such that the beams reflected off of the second reflective surface define a common focus point.

6. The system of claim 1, wherein the plurality of reflected beams define a beam path plane.

7. The system of claim 6, wherein the means for translating is configured to translate the at least one glass sheet through the cavity to and through a first position in which the plane of the glass sheet and the beam path plane define a common axis comprising the common focus point, wherein in the first position the glass sheet plane defines a predetermined angle with respect to the beam path plane and a predetermined complementary angle with respect to a third plane that comprises the common axis and is transverse to the beam path plane.

8. The system of claim 7, wherein the means for translating is configured to translate the glass sheet in the machine direction through the cavity such that the predetermined angle is maintained while at least a portion of the glass sheet passes through the common focus point.

9. The system of claim 7, wherein the means for translating is configured to translate the glass sheet in the machine direction through the cavity along a second axis that is perpendicular to the common axis, wherein the second axis is at the predetermined angle in relation to beam path plane.

10. The system of claim 7, wherein the predetermined complementary angle is substantially Brewster's angle.

11. The system of claim 7, wherein the predetermined complementary angle is from about 54 degrees to about 60 degrees.

12. The system of claim 7, wherein the predetermined complementary angle is from about 55 to about 57 degrees.

13. The system of claim 7, wherein the predetermined complementary angle is approximately 56 degrees.

14. The system of claim 7, wherein the laser is polarized in a plane transverse to the common axis.

15. The system of claim 1, wherein the means for translating is configured to translate the at least one glass sheet through the cavity at a predetermined speed.

16. The system of claim 1, wherein the means for translating is configured to translate the at least one glass sheet through the cavity more than once.

17. The system of claim 1, wherein the laser is a continuous wave laser.

18. The system of claim 1, wherein the laser is a fiber laser.

19. The system of claim 1, wherein the laser is a diode pigtailed laser

20. The system of claim 1, wherein the laser operates in the near infrared wavelength band.

21. The system of claim 1, wherein the laser beam is polarized.

22. The system of claim 1, wherein the laser beam is linearly p-polarized.

23. The system of claim 1, wherein the at least one glass sheet comprises a plurality of glass sheets in a stacked arrangement.

24. The system of claim 1, wherein the at least one glass sheet comprises glass having an absorption in a range of about 0.001/cm to about 0.01/cm.

25. The system of claim 1, wherein the at least one glass sheet comprises glass having an absorption in a range of about 0.01/cm to about 0.1/cm.

26. The system of claim 1, wherein the at least one glass sheet comprises glass having an absorption in a range of about 0.1/cm to about 1.0/cm.

27. The system of claim 1, wherein the at least one glass sheet comprises glass having a coefficient of thermal expansion in a range of about 1×10⁻⁶/° C. to about 2×10⁻⁶/° C.

28. The system of claim 1, wherein the at least one glass sheet comprises glass having a coefficient of thermal expansion in a range of about 2×10⁻⁶/° C. to about 4×10⁻⁶/° C.

29. The system of claim 1, wherein the at least one glass sheet comprises glass having a coefficient of thermal expansion in a range of about 4×10⁻⁶/° C. to about 1×10⁻⁵/° C.

30. The system of claim 1, wherein the at least one glass sheet comprises glass having an absorption in a range of about 0.01/cm to about 0.1/cm and a coefficient of thermal expansion in a range of about 2×10⁻⁶/° C. to about 4×10⁻⁶/° C.

31. The system of claim 1, wherein the first mirror defines an aperture therethrough the first reflective surface, and wherein the laser is configured to emit the beam into the cavity therethrough the aperture.

32. A method for cutting at least one glass sheet, comprising:
providing a first mirror comprising a first reflective surface;
providing a second mirror comprising a second reflective surface that is spaced from and opposes the first reflective surface, and wherein the first reflective surface and the second reflective surface define a cavity therebetween;
providing a laser configured to emit a beam;
projecting the beam into the cavity; and
translating the at least one glass sheet through the cavity in a machine direction.

33. The method of claim 32, wherein the step of projecting the beam therethrough the aperture into the cavity comprises positioning the laser such that the beam is reflected off of at least the second reflective surface a plurality of times to form a plurality of reflected beams, and wherein the plurality of reflected beams define a beam path plane.

34. The method of claim 33, wherein the first reflective surface is concave relative to the cavity and has a first radius of curvature, the second reflective surface is concave relative to the cavity and has a second radius of curvature, and wherein the second radius of curvature is selected such that the plurality of reflected beams define a common focus point.

35. The method of claim 34, wherein the step of translating the at least one glass sheet comprises translating the at least one glass sheet to and through a first position in which the plane of the glass sheet and the beam path plane define a common axis comprising the common focus point, and wherein in the first position the glass sheet plane defines a predetermined angle with respect to the beam path plane and a predetermined complementary angle with respect to a third plane that comprises the common axis and is transverse to the beam path plane.

36. The method of claim 35, wherein the step of translating the at least one glass sheet further comprises maintaining the predetermined angle.

37. The method of claim 35, wherein the step of translating the at least one glass sheet further comprises translating the glass sheet along a second axis perpendicular to the common axis, the second axis being at the predetermined angle in relation to the beam path plane.

38. The method of claim 35, wherein the predetermined complementary angle is substantially Brewster's angle.

39. The method of claim 32, wherein the step of translating the at least one glass sheet comprises translating the glass sheet at a predetermined speed.

40. The method of claim 32, further comprising the step of scribing a portion of an edge of the at least one glass sheet, the step of scribing occurring prior to the step of translating the at least one glass sheet through the cavity.

41. The method of claim 32, wherein the at least one glass sheet comprises a plurality of glass sheets, wherein the method further comprises arranging the plurality of glass sheets in a stacked arrangement.

42. The method of claim 32, wherein the first mirror defines an aperture therethrough the first reflective surface and wherein the step of projecting the beam into the cavity comprises projecting the beam therethrough the aperture into the cavity.
